(19) United States
(12) Patent Application Publication
(10) Pub. No.: US 2014/0014624 A1
(43) Pub. Date: Jan. 16, 2014

(54) WIRE ELECTRIC DISCHARGE MACHINE WITH MACHINING POWER SOURCE SWITCHABLE FOR WIRE CUTTING

(71) Applicant: FANUC CORPORATION, Yamanashi (JP)

(72) Inventors: Masayuki YOSHIDA, Minamitsuru-gun (JP); Akiyoshi KAWAHARA, Minamitsuru-gun (JP)

(73) Assignee: FANUC CORPORATION, Yamanashi (JP)

(21) Appl. No.: 13/873,760

(22) Filed: Apr. 30, 2013

(30) Foreign Application Priority Data
Jul. 10, 2012 (JP) 2012-154965

(51) Int. Cl. B23H 1/02

(52) U.S. Cl. CPC B23H 1/02
USPC 219/69.12; 219/69.13

(57) ABSTRACT

The wire electric discharge machine comprises a machining power source with variable output voltage, a first power supply path through which a discharge pulse current is supplied from the power source by applying a voltage at machining gap to cause electric discharge, and a second power supply path through which a wire electrode cutting current is supplied from the power source to the wire electrode, and also comprises a switching device to switch the first and second power supply paths. Discharge pulse current is supplied through the first power supply path when machining the workpiece, whereas wire cutting current is supplied when cutting the wire electrode.

### BACKGROUND OF THE INVENTION

1. Field of the Invention

The present invention relates to a wire electric discharge machine in which an electric discharge machining power source can be switched to be used as a power source for wire electrode cutting.

2. Description of the Related Art

A wire electric discharge machine performs electric discharge machining in such a manner that a wire electrode is stretched between upper and lower wire guides and a discharge pulse current is applied between the wire electrode and a workpiece. The discharge pulse current can be obtained by turning switching elements on and off by means of a current from a DC power source (hereinafter referred to “machining power source”) and taking advantage of charge and discharge of a capacitor. As shown in FIG. 1, the discharge pulse current has a sharp pulse waveform. In machining a plurality of portions of one or more workpieces through continuous unattended operation of the wire electric discharge machine, moreover, the wire electrode is automatically cut and moved to the next machining position when machining of one portion (in a machining position) is finished. In the next machining position, the wire electrode is automatically threaded to be ready for the next machining operation.

Japanese Patent Application Laid-Open No. 2006-7400 discloses a wire electrode cutting method in which a cutting current for thermally cutting a wire electrode is applied to the wire electrode under tension. A conventional wire electric discharge machine is furnished with a power source (hereinafter referred to as “cutting power source”) for applying the cutting current to the wire electrode. As disclosed in Japanese Patent Application Laid-Open No. 2-53528, the conventional wire electric discharge machine comprises a dedicated cutting power source for cutting the wire electrode, besides a machining power source. Both the machining and cutting power sources are configured so that the power of current is adjustable. In a system described in Japanese Utility Model Application Laid-Open No. 4-9225, a machining power source is used in place of a cutting power source, and its output current is a machining current for electric discharge machining available at various output levels.

The following is a description of the difference between a machining circuit comprising the machining power source and a cutting circuit comprising the cutting power source. The machining circuit for electric discharge machining normally does not comprise a current limiting circuit based on resistors, and outputs a pulse current by adjusting the on-times of switching elements and taking advantage of charge and discharge of a capacitor (see FIG. 1). On the other hand, the cutting circuit for wire electrode cutting outputs a constant current limited by the resistors. If the discharge pulse current for electric discharge machining output from the machining circuit is used in applying the wire electrode cutting current to thermally cut the wire electrode, the wire electrode is heated so unevenly that it cannot be successfully cut. For example, the wire electrode may be bent or the distal end of a wire electrode cutting portion may be broken, in some cases.

In the wire electric discharge machine, a workpiece is machined with the wire electrode stretched between the upper and lower wire guides, so that the power sources for electric discharge machining and wire electrode cutting are not used simultaneously.

### SUMMARY OF THE INVENTION

Accordingly, the object of the present invention is to provide a wire electric discharge machine configured so that power supply paths from a power source to a wire electrode and a workpiece are provided individually for electric discharge machining of the workpiece and wire electrode cutting and are switched by means of a power supply path switching device to enable sharing of the power source, whereby the wire electric discharge machine is simplified.

In a wire electric discharge machine according to the present invention, a wire electrode is stretched between an upper wire guide and a lower wire guide, and a voltage is applied between the wire electrode and a workpiece to cause electric discharge, thereby performing electric discharge machining of the workpiece. The wire electric discharge machine comprises a machining power source with variable output voltage, a first power supply path through which a discharge pulse current is supplied from the machining power source by applying a voltage based on machining conditions between the wire electrode and the workpiece to cause electric discharge, a second power supply path through which a wire electrode cutting current for cutting the wire electrode is supplied from the machining power source to the wire electrode, and a power supply path switching device configured to switch the first and second power supply paths. The machining power source is configured so that voltage for electric discharge machining is output therefrom to supply the discharge pulse current through the first power supply path when machining the workpiece and that a voltage for cutting the wire electrode is output therefrom to supply the cutting current through the second power supply path when cutting the wire electrode.

The first power supply path may comprise a switching element and a capacitor, whereby a voltage based on machining conditions is applied between the wire electrode and the workpiece so that a desired pulse current is supplied from the machining power source, and the second power supply path may comprise a plurality of current limiting resistors and a switch configured to change combinations of the current limiting resistors, whereby a voltage corresponding to the wire electrode is applied from the machining power source so that the wire electrode cutting current is supplied.

According to the present invention, it is possible to provide a wire electric discharge machine configured so that power supply paths from a power source to a wire electrode and a workpiece are provided individually for electric discharge machining of the workpiece and wire electrode cutting and are switched by means of a power supply path switching device to enable sharing of the power source.

### BRIEF DESCRIPTION OF THE DRAWINGS

The above and other objects and features of the present invention will be obvious from the ensuing description of embodiments with reference to the accompanying drawings, in which:

FIG. 1 is a diagram illustrating a discharge pulse current; and

FIG. 2 is a diagram illustrating an outline of a configuration of one embodiment of a wire electric discharge machine according to the present invention.

### DETAILED DESCRIPTION OF THE PREFERRED EMBODIMENTS

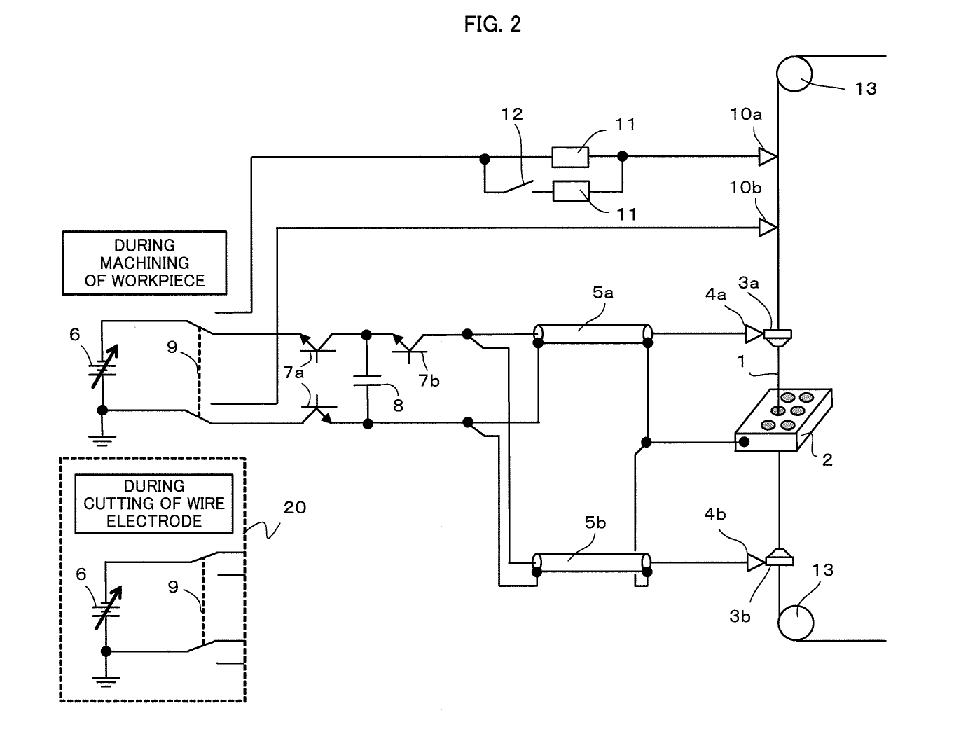

One embodiment of a wire electric discharge machine according to the present invention will be described with reference to FIG. 2.

In general, the wire electric discharge machine, which is controlled by a numerical controller (not shown), relatively moves a wire electrode 1 with respect to a table on which a workpiece 2 is placed, while applying a voltage for electric discharge machining between the wire electrode 1 and the workpiece 2, thereby machining the workpiece 2. If the wire electrode 1 is broken, its supply-side distal end portion is partially cut. Thereafter, the wire electrode 1 is returned to a machining start hole or the like, whereupon the wire electric discharge machine performs automatic wire connection and then resumes the electric discharge machining.

The wire electrode 1 wound on a wire bobbin (not shown) is passed through a roller 13 for wire electrode traveling, an upper wire guide 3a, the workpiece 2, a lower wire guide 3b, and the roller 13, and is collected in a wire electrode collection device (not shown).

The wire electric discharge machine machines the workpiece 2 with the wire electrode 1 tensioned at least between the upper and lower wire guides 3a and 3b. Thus, power sources for workpiece machining and wire electrode cutting are not used simultaneously. According to the present invention, therefore, a power supply path from a machining power source 6 to the workpiece 2 is provided during machining of the workpiece, while a power supply path from the machining power source 6 to the wire electrode 1 is provided (separately from the power supply path leading to the workpiece 2) while the wire electrode is being cut. The single machining power source 6 can also be used as the power source for wire electrode cutting by switching the two power supply paths, which are connected to the machining power source, by means of a power supply path switching device 9. A DC power source with variable output voltage is used for the machining power source 6. Thus, the wire electric discharge machine can be constructed such that the machining power source 6 can be switched for use in wire electrode cutting. In this way, the wire electric discharge machine can be simplified.

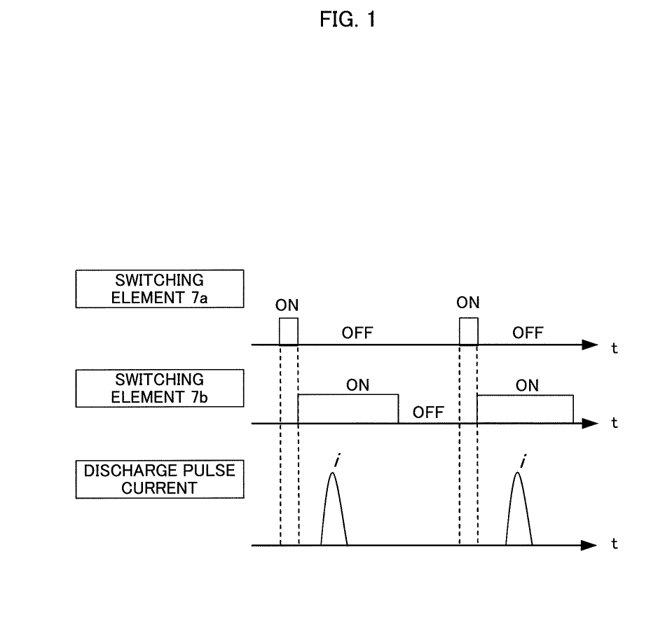

In machining the workpiece 2 using the wire electric discharge machine, the voltage is applied between the wire electrode 1 and the workpiece 2, thereby causing electric discharge between them. The voltage is applied to the gap (electrode gap) between the electrode 1 and the workpiece 2 through first upper and lower feeding units 4a and 4b at one end and upper and lower feeder lines 5a and 5b connected to the workpiece 2 at the other end. Thus, a discharge pulse current is supplied from the machining power source 6, for use as a variable-voltage DC power source, to the gap between the wire electrode 1 and the workpiece 2. The discharge pulse current can be obtained by turning switching elements 7a and 7b on and off and taking advantage of charge and discharge of a capacitor 8 (see FIG. 1).

In cutting the wire electrode 1, on the other hand, the power supply path switching device 9 is switched, as indicated within a broken-line rectangle 20, to supply a current for wire electrode cutting from the machining power source 6 to second upper and lower feeding units 10a and 10b above the upper wire guide 3a. This current for wire electrode cutting is a limited constant current supplied through current limiting resistors 11. Further, the current for wire electrode cutting is limited in stages and its waveform is changed as the combined resistance of the current limiting resistors 11 is changed by a switch 12. Although the two current limiting resistors 11 are used in the example shown in FIG. 2, the number thereof is not limited to two.

The machining power source 6 outputs necessary voltages for workpiece machining and wire electrode cutting, individually. In machining the workpiece, for example, a voltage is output corresponding to machining conditions, including input machining energy, machining state of the workpiece (number of machining cycles), material and wall thickness of the workpiece, and material and diameter of the wire electrode. In cutting the wire electrode, on the other hand, voltage corresponding to the material and diameter of the wire electrode is output.

1. A wire electric discharge machine, in which a wire electrode is stretched between an upper wire guide and a lower wire guide, and a voltage is applied between the wire electrode and a workpiece to cause electric discharge, thereby performing electric discharge machining of the workpiece, the wire electric discharge machine comprising:
a machining power source with variable output voltage;
a first power supply path through which a discharge pulse current is supplied from the machining power source by applying a voltage based on machining conditions between the wire electrode and the workpiece to cause electric discharge;
a second power supply path through which a wire electrode cutting current for cutting the wire electrode is supplied from the machining power source to the wire electrode; and
a power supply path switching device configured to switch the first and second power supply paths, wherein
the machining power source is configured so that voltage for electric discharge machining is output therefrom to supply the discharge pulse current through the first power supply path when machining the workpiece and that a voltage for cutting the wire electrode is output therefrom to supply the cutting current through the second power supply path when cutting the wire electrode.

2. The wire electric discharge machine according to claim 1, wherein the first power supply path comprises a switching element and a capacitor, whereby a voltage based on machining conditions is applied between the wire electrode and the workpiece so that a desired pulse current is supplied from the machining power source and wherein
the second power supply path comprises a plurality of current limiting resistors and a switch configured to change combinations of the current limiting resistors, whereby a voltage corresponding to the wire electrode is applied from the machining power source so that the wire electrode cutting current is supplied.
